(19) United States
(12) Patent Application Publication
(10) Pub. No.: US 2026/0269539 A1
(43) Pub. Date: Sep. 10, 2026

(54) ELECTRICAL CONNECTION SYSTEM INCLUDING SHIELD AND MATING COMPONENT WITH CONTACTS AND METHOD FOR FORCE AND GROUNDING DISTRIBUTION

(71) Applicant: Yazaki North America, Inc., Canton, MI (US)

(72) Inventor: Robert Steven Massar, Canton, MI (US)

(21) Appl. No.: 19/073,404

(22) Filed: Mar. 7, 2025

(51) Int. Cl. H01R 13/6591; B60R 16/02; H01R 13/6581

(52) U.S. Cl. CPC H01R 13/65912; B60R 16/0215; H01R 13/6581; H01R 2201/26

(57) ABSTRACT

An electrical connection system for a wire harness and method of use can include providing an electromagnetically shielded cable and target mating component. The system can include a first electrical terminal, a shield shell covering at least a portion of the first electrical terminal and having a first substantially planar surface. A mating component can include a second substantially planar surface opposing the first substantially planar surface. A bolt can connect the shield shell and the mating component. At least one contact can protrude from at least one of the first substantially planar surface and the second substantially planar surface. The contact can abut and form a grounding connection between the first substantially planar surface and the second substantially planar surface when the bolt fastens the shield shell and the mating component together.

### BACKGROUND

The disclosed subject matter relates to shields and methods for securing and protecting an electrical terminal. In particular, the disclosed subject matter relates to shielded connectors for high voltage wire harnesses in a vehicle, the shield including grounding and force distribution contact features.

In a vehicle, an electromagnetic compatibility (EMC) shield is commonly used to prevent electromagnetic interference (EMI) or radio frequency interference (RFI) from, for example, the high voltage wiring harness and its connections from impacting sensitive electronics in the vehicle. This can be achieved by using a metallic screen or cover to absorb the electromagnetic interference that is transmitted through the air. The screen or cover absorbs the transmitted signals, and causes a current within the body of the screen or cover. This current can be absorbed by a ground connection.

By absorbing these transmitted signals before they reach sensitive circuitry, the protected signal is kept clean of electromagnetic interference, maximizing shielding effectiveness.

Several techniques and materials can be used for EMC shielding, and the materials used depend on the type of electronics and frequencies involved. This is because the amount of signal reduction/blocking depends on the material used, the size of the shielded volume, the material thickness as well as other factors. Each of these factors affects the range and strength of frequencies that can be absorbed by the shielding.

Some examples of EMC shielding material include metallic foil or plaited braid to shield equipment wires and connections. The connectors on the ends of the wire can be protected using metal covers, and the braiding or foil from the wires can be attached to the metal cover to enhance EMC shielding.

Conductive paints and magnetic materials can also be used in certain environments. Other EMC shielding materials can include sheet metal, metal foam, conductive plastics, and mesh-metal screening.

Depending on the frequency, the shielding does not have to be a solid screen, but can have regularly placed holes, or wire fencing. It is therefore important to understand exactly which part of the electromagnetic frequency spectrum needs to be guarded against in any particular application.

Ultimately, shielding is beneficial where any sensitive electronic element requires isolation from the surrounding electromagnetic fields, or where a particular element is transmitting unwanted additional signals.

There are many problems and issues in the shielded connector technology that have been addressed and are yet unresolved to date. For example, many shielded connectors include multiple fasteners to ensure proper force distribution about a perimeter of the shield when connected to a target structure or device. The additional connectors add to part cost and increase the manufacturing time and repair time for the connectors. In addition, the multiple parts create multiple locations for possible failure of the shield and does not provide a consistent predictable pathway for electrical grounding of the shield. Other connectors have used spring contacts that, again, increase the complexity, cost and assembly time of the shield, while making the pathway for electrical grounding of the shield less reliable due to changes in spring constants, spring wear, and precise placement requirements of each of the spring components relative to the shield. Conductive gaskets have also been used in an attempt to provide more predictable contact and electrical pathways in a shield structure. However, gaskets increase the number of parts required (and cost), increase assembly time, decrease ability to meet manufacturing tolerances, and in general are susceptible to failure due to wear or misalignment and general complexity.

In cast shield shells that have a planar surface intended to mate with a target device's opposing mating surface, the flat as-cast geometry does not guarantee good contact force and therefore force distribution and location and size of electrical grounding pathways are unpredictable. Shielding effectiveness is reduced as distance from a fastener bolt increases when a shield's planar mating surface mates with a target device or structure's planar mating surface. Contact force and the grounding electrical pathway are only predictable near each fastener where high contact force exists. Contact force (and therefore grounding electrical pathways) are less and less predictable the further away from a fastener when a planar surface to planar surface connection exists in the shielded connector.

### SUMMARY

In accordance with an aspect of the disclosed subject matter, an electrical connection system for a wire harness that includes an electromagnetically shielded cable can include, a first electrical terminal, a shield shell covering at least a portion of the first electrical terminal and having a first substantially planar surface, a mating component including a second substantially planar surface configured to oppose the first substantially planar surface, at least one bolt configured to extend through at least a portion of each of the shield shell and the mating component, and at least one contact protruding from at least one of the first substantially planar surface and the second substantially planar surface, the at least one contact abutting and forming a grounding connection with a different one of the first substantially planar surface and the second substantially planar surface when the bolt fastens the shield shell and the mating component together.

In accordance with another aspect of the disclosed subject matter, an electrical connection system for shielding an electrical terminal can include, a shield shell configured to cover at least a portion of the electrical terminal and having a first substantially planar surface, a mating component including a second substantially planar surface configured to oppose the first substantially planar surface, at least one bolt having a rotational axis and configured to extend through at least a portion of each of the shield shell and the mating component, and at least one contact protruding from at least one of the first substantially planar surface and the second substantially planar surface and abutting and forming a grounding connection with a different one of the first substantially planar surface and the second substantially planar surface, and the first substantially planar surface and the second substantially planar surface are perpendicular to the rotational axis of the at least one bolt.

In accordance with another aspect of the disclosed subject matter, an electrical connection system for a connector of a wire harness can include, a first housing shell having a first substantially planar surface, a mating component having a second substantially planar surface configured to mate with the first substantially planar surface of the first housing shell to contain and shield the connector, and a bolt extending in a first direction through at least a portion of each of the first housing shell and mating component, wherein at least one of the first substantially planar surface and second substantially planar surface includes a plurality of contacts extending in a direction parallel to the first direction and away from the at least one of the first substantially planar surface and second substantially planar surface, the contacts are located about a periphery of the at least one of the first substantially planar surface and second substantially planar surface, the plurality of contacts are configured to contact and form a grounding connection with the substantially planar surface of an opposing one of the first substantially planar surface and second substantially planar surface.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1A is a side partial cross-sectional view of a connector made in accordance with principles of the disclosed subject matter.

FIGS. 1B and 1C are close up views of portions of FIG. 1A.

FIG. 2A is a bottom view of the shield shell and wires of FIG. 1A.

FIG. 2B is a close up view of a portion of FIG. 2A.

FIG. 3A is a front view of another embodiment of a connector made in accordance with principles of the disclosed subject matter.

FIGS. 3B and 3C are close up views of portions of FIG. 3A.

FIG. 4A is a front view of another embodiment of a connector made in accordance with principles of the disclosed subject matter.

FIG. 4B is a side view of the connector of FIG. 4A.

FIG. 4C is a bottom view of the shield shell and wires of FIG. 4A.

FIG. 5A is a side view of another embodiment of a connector made in accordance with principles of the disclosed subject matter.

FIG. 5B is partial bottom view of the connector of FIG. 5A.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

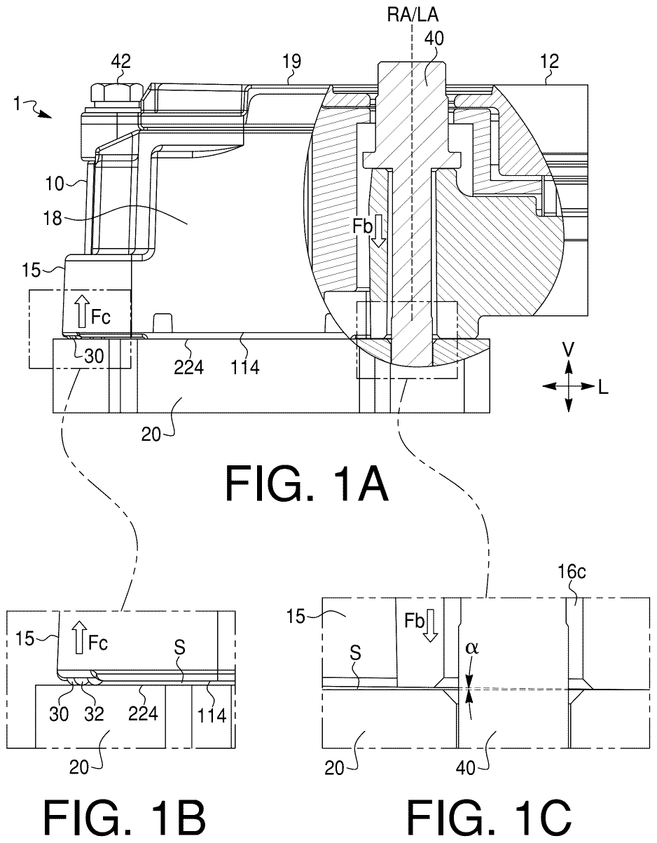

FIG. 1A is a side partial cross-sectional view of a connector 1 made in accordance with principles of the disclosed subject matter. The connector 1 can include a shield shell 10. In this embodiment, the shield shell 10 is a two part shield shell 10 that includes an upper shield 12 and a lower shield 15. The shield shell 10 can be designed to cover wires 50 and electrical terminal 54 which transfer electricity from the wires 50 to/from a target or mating component 20, such as a motor, an inverter, a battery, or other electronic equipment. The shield shell 10 can be connected to the mating component 20 using a bolt 40. In other embodiments, multiple bolts can be used to secure the shield shell 10 to the mating component 20. Bolts 42 can connect the upper shield 12 to the lower shield 15. Contacts 30 can be provided on or formed in either the shield shell 10 or the mating component 20 in either the lowermost surface 114 of shield shell 10 or the uppermost surface 224 of the mating component 20.

The lowermost surface 114 of the shield shell 10 can be considered the surface that is the lowermost surface in a direction parallel to a longitudinal axis LA of bolt 40 and/or rotational axis RA of bolt 40, and away from the top surface 19 of the shield shell 10. At least portions of the lowermost surface 114 reside in a single plane that is oriented perpendicular to the rotational axis RA of the bolt 40 such that connective force from the bolt 40 can be distributed about a peripheral wall 18 of the shield shell 10 in a direction parallel with the rotational axis RA of the bolt 40.

The uppermost surface 224 of the mating component 20 can be configured to mate with (e.g., be substantially parallel to when connected) the lowermost surface 114 of the shield shell 10. At least portions of the uppermost surface 224 reside in a single plane that is oriented perpendicular to the rotational axis RA of the bolt 40 such that connective force from the bolt 40 can be distributed from the peripheral wall 18 of the shield shell 10 in a direction parallel with the rotational axis RA of the bolt 40 and into the mating component 20 when the bolt is tightened (e.g. when the bolt 40 is rotated about its rotational axis RA to secure the shield shell 10 to the mating component 20).

Contacts 30 can be located on either the lowermost surface 114 of the shield shell 10 or the uppermost surface 224 of the mating component. The contacts 30 can be formed as a structure that protrudes from the substantially planar lowermost surface 114 or substantially planar uppermost surface 224. The contacts 30 can be formed as a single structure at particular locations, or can be formed as multiple structures, such as semispherical protrusions 32, at each particular location. The locations for the contacts 30 can be chosen in order to distribute force in a particular manner from the shield shell 10 to the mating component 20, and in order to provide pre-set and defined electrical grounding pathways for the shield shell 10 through to the mating component 20.

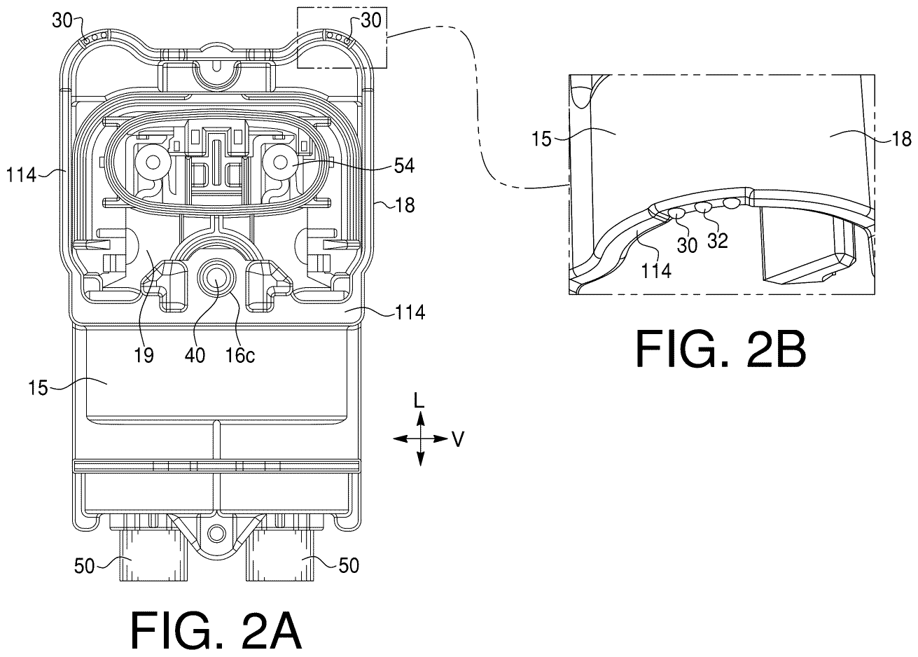

For example, as shown in the close up views of FIGS. 1B and 1C, the contacts 30 can be located in an asymmetrical relationship with respect to the bolt 40 as viewed from a side of the connector 1 such that when the bolt 40 is tightened to secure the shield shell 10 to the mating component 20, the lowermost surface 114 of the shield shell 10 will form an angle ∝with respect to the uppermost surface 224 of the mating component 20. In addition, the contacts 30, 32 located at a leftmost position of the connector 1 as viewed from the side will cause a space S to be formed between the lowermost surface 114 of the shield shell 10 and the uppermost surface 224 of the mating component 20. The space S extends from the bolt 40 to the contacts 30 on the left side of the bolt 40 (the side extending away from the wires 50). The lowermost surface 114 of the shield shell 10 contacts the uppermost surface 224 of the mating component 20 to the right of the bolt 40 (towards the wires 50) in the embodiment shown in FIGS. 1A-C. Thus, connective contact force Fc (and an electrical grounding pathway) are concentrated at the location of the contacts 30 to the left of the bolt 40. The downward force of the bolt Fb is shown adjacent the bolt 40. Another contact force and electrical grounding pathway is located at the surface contact area to the right of the bolt 40, with space S separating the shield shell 10 from the mating component 20 between these contact/concentration locations. The forces Fc and Fb are shown in the vertical V direction of FIGS. 1A-C which is parallel with the longitudinal or rotational axis RA of the bolt 40 and substantially perpendicular to the planar lower most surface 114 of the shield shell 10 and planar uppermost surface 224 of the mating component 20. The wires 50 (shown in FIG. 2A) can enter the shield shell 10 in a lateral direction L substantially (exactly or almost) perpendicular to the longitudinal or rotational axis RA of the bolt 40.

The bolt 40 extends through an aperture 16c that runs through the shield shell 10 and into the mating component 20. If the bolt 40 is formed as a threaded fastener, the mating component 20 (and/or shield shell 10) can include a threaded portion of aperture 16c for connecting to the bolt 40 and providing the ability to clamp the shield shell 10 to the mating component 20 by force when the bolt is rotated and threads of the bolt 40 are received in threads of the mating component 20/shield shell 10. Alternatively, if the bolt 40 is configured as a rivet type structure or a bolt and nut type structure, a lowermost surface of the mating component 20 (or an uppermost surface of the top surface 19 of shield shell 10) can include a rivet or nut or weld structure that secures the shaft of the bolt in the aperture 16c. Other structures, including but not limited to clamps, adhesives, and cotter pins can be used to secure the shaft of the bolt 40 within aperture 16c and secure the shield shell 10 to the mating component 20.

FIG. 2A is a bottom view of the shield shell 10 and wires 50 of the connector 1 of FIG. 1A. In this view, the location of the contacts 30 can be seen at the upper right and upper left corners of the shield shell 10. The upper corners being the furthermost corners in a longitudinal axis direction L away from a side in which wires 50 enter the connector 1, and the longitudinal axis direction L being the direction in which wires 50 extend into shield shell 10. The aperture 16c with bolt 40 located therein is located between the contacts 30 and the wires 50 in the longitudinal axis direction L of the connector 1. The wires 50 are connected to electrical terminals 54 inside the shield shell 10, and the electrical terminals 54 allow for electrical connection of the wires 50 to the mating component 20 (e.g., to a motor, inverter, battery, etc.). The shield shell 10 can include a peripheral wall 18 that extends from the top surface 19 of the upper shell 12 to define a housing within which the electrical terminals 54 reside and are protected. The outermost periphery of the connector 1 is defined by the peripheral wall 18 which, in the present embodiment, has a planar surface 114 extending around the entire periphery of a bottom surface of the peripheral wall 18. The planar surface 114 can exist in a single plane, and face towards the mating component 20 (facing away from the top surface 19 of the upper shell 12). The single plane in which the planar surface 114 exists is perpendicular to the rotational axis RA (or longitudinal axis LA—which is into the paper in FIG. 2A) of the bolt 40. Thus, when the bolt 40 is rotated or otherwise tightened to cause the shield shell 10 to move towards the mating component 20, the force Fb of the bolt 40 is in a direction substantially perpendicular (perpendicular or at a slight angle ∝) to the planar surface 114. The countering force Fc from the contacts 30 located about the peripheral wall and on the planar surface 114 is also substantially perpendicular to the planar surface 114.

FIG. 2B is a close up view of a portion of FIG. 2A and shows a more detailed view of the contacts 30 and the semispherical projections 32 that make up each distinct contact 30. The contacts 30 are defined by an isolated surface(s) that projects slightly from the lowermost planar surface 114 of the shield shell 10 such that force of connection and electrical pathways between the shield shell 10 and mating component 20 are concentrated at each contact 30. It should be noted that when the shield shell 10 is a two part (or multiple part) shield shell (e.g., including upper shield 12 and lower shield 15), the lowermost planar surface 114 can be located about a peripheral wall 18 that is formed at least in part by the lower shield 15 portion of the shield shell 10.

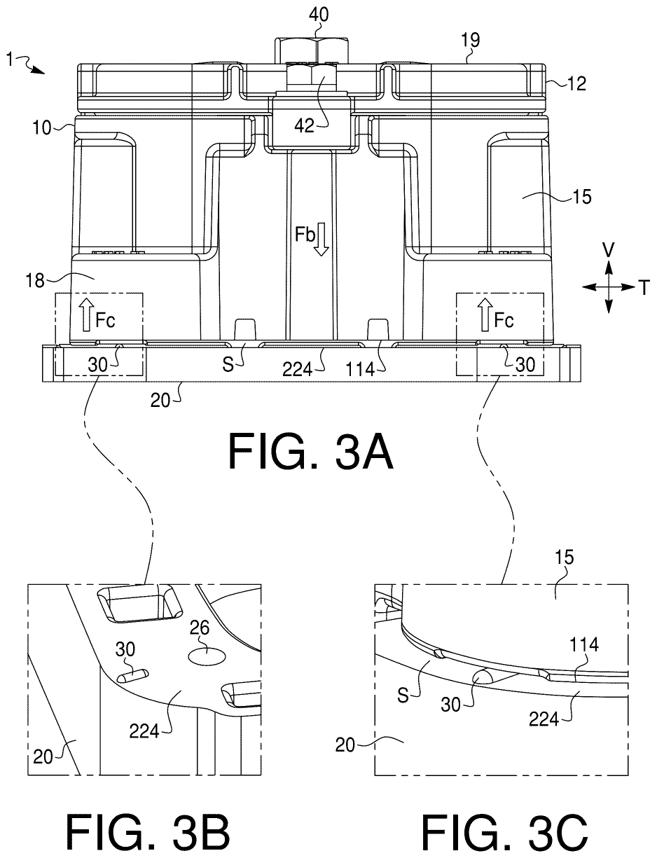

FIG. 3A is a front view of another embodiment of a connector 1 made in accordance with principles of the disclosed subject matter. The connector 1 includes a mating component 20 that can be cast (or otherwise manufactured) with contacts 30 formed during the casting procedure. The contacts 30 can extend upward in a direction away from a planar uppermost surface 224 of the mating component 20, and contact a lowermost planar surface 114 of the shield shell 10 when assembled thereto. A bolt 40 can be used to provide the connective force between the mating component 20 and the shield shell 10 and to draw them together. In this embodiment, the shield shell 10 is a two piece shell with an upper shield 12 and a lower shield 15. A bolt 42 can connect the upper shield 12 to the lower shield 15. The lowermost surface 114 of the lower shield 15 can mate with the uppermost surface 224 of the mating component 20. A peripheral wall 18 can extend from the top surface 19 of the upper shield 12 to the lowermost surface 114 of the lower shield 15. The peripheral wall 18 can be a singular structure or made up of separate walls formed by each of the upper shield 12 and lower shield 15. At the lowermost portion of the wall 18, at least one planar surface 114 can be formed to define the lowermost portion of the shield 10 in the direction parallel with the longitudinal axis or rotational axis of bolt 40.

FIGS. 3B and 3C are close up views of portions of FIG. 3A that show the contact 30 formed (e.g., cast) in the uppermost surface 224 of the mating component 20. The contact 30 can be formed in a pill shape, with a cylindrical main body and a quarter sphere located at opposite ends of the tubular main body. Thus, a contact line can be formed at an uppermost diameter of the tubular main body. This contact line of the contact 30 will provide the main path for distributing both force and electrical grounding connection from the shield 10 to the mating component 20. An aperture 26 can be provided in mating component 20 for use in other embodiments should a threaded connection be desired at that location for connecting the shield shell 10 to the mating component 20. The upward force Fc that contacts 30 apply to the lowermost surface 114 of the shield shell 10 can be symmetrically located on either side of bolt 40 as viewed from a front (i.e., along longitudinal axis) of the connector 1. A space S can be formed between the uppermost surface 224 and lowermost surface 114 at locations between each contact 30 such that connective force and electrical grounding pathways are concentrated at the contacts 30 in a predictable and cost effective manner. The mating component 20 (and/or shield shell 10) of this embodiment can include contacts 30 located on an opposite side of the bolt 40 in a the longitudinal direction such that only contacts 30 provide connective junctures between the shield shell 10 and mating component 20. In that case, the lowermost surface 114 and uppermost surface 224 will be substantially parallel with respect to each other and spaced from each other at locations away from the contacts 30. Alternatively, no contacts 30 can be provided on an opposite side of the bolt 40 in a the longitudinal direction such that a cast planar surface of each of the shield shell 10 and mating component 20 provide the electrical grounding pathway and force connection at a location behind the bolt 40 (as viewed “into the paper” and along the longitudinal axis direction in FIG. 3A). In this manner, the uppermost surface 224 and lowermost surface 114 will be at an angle ∝ with respect to each other as viewed from a side (i.e., from a right side of FIG. 3A or from a perspective along a transverse axis direction T).

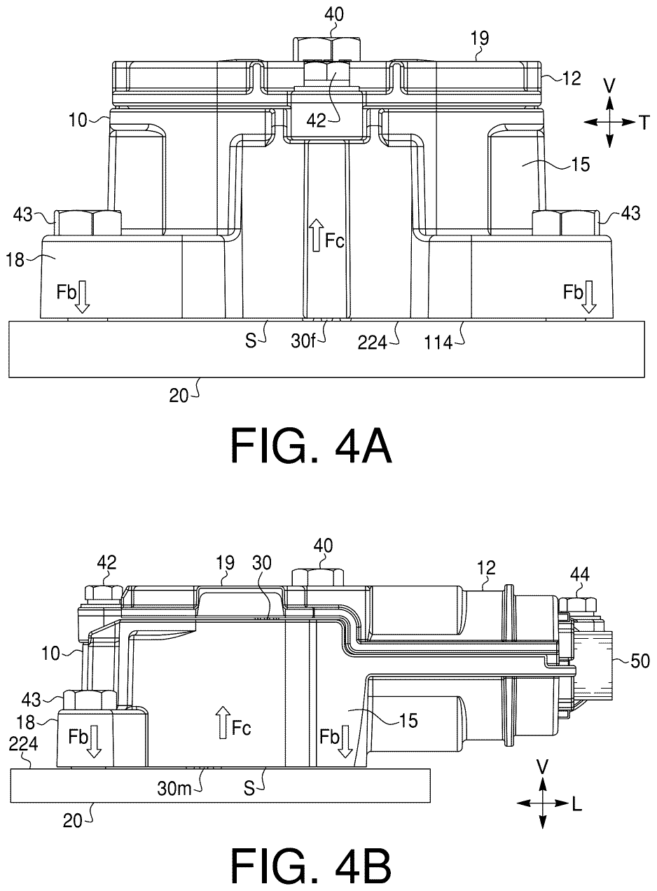

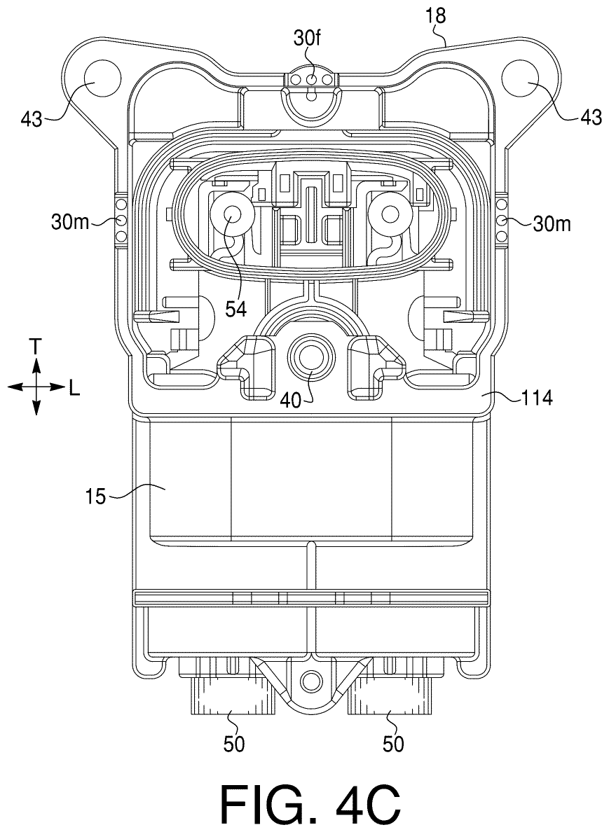

FIG. 4A is a front view of another embodiment of a connector 1 made in accordance with principles of the disclosed subject matter. In this embodiment, instead of a single bolt 40 attaching the shield shell 10 to the mating component 20 (as shown in the embodiment of FIG. 1), the connector 1 can include two front bolts 43 and a central bolt 40 that can be used to secure the shield shell 10 to the mating component 20. Thus, the force Fb of the bolts 43 can counter the force Fc of the contact 30f that is symmetrically located between the front bolts 43 as viewed from the front in FIG. 4A (i.e., as viewed from a longitudinal axis position).

FIGS. 4B and C are a side view and a bottom view of the shield shell 10 and wires 50 of the connector 1 of FIG. 4A, respectively, and show the symmetrical relationship from a side view of the middle two contacts 30m with respect to the bolts 40 and 43 located on either side of the contacts 30m as viewed from a side of the connector 1 as shown in FIG. 4B (i.e., as viewed from a transverse axis position). Thus, the force Fb of the bolts 43 is spaced equidistant (as viewed from the lateral axis direction L and from the transverse axis direction T) and on either side of the counteracting force Fc of the contacts 30m. The placement of the contacts 30m and 30f can ensure a balanced force distribution around the peripheral wall 18 of the shield shell 10. Further, the contacts 30m and 30f extend slightly away from the lowermost surface 114 of the lower shield 15 in this embodiment to provide specific and predictable grounding and force pathways for the shield shell 10. Electrical terminals 54 can be centrally located in the shield shell 10 such that the contacts 30m, 30f and bolts 40, 43 are spaced about a perimeter of the lowermost surface 114 of the peripheral wall 18 to surround the electrical terminals 54 as viewed from a vertical axis V (shown in FIG. 4C).

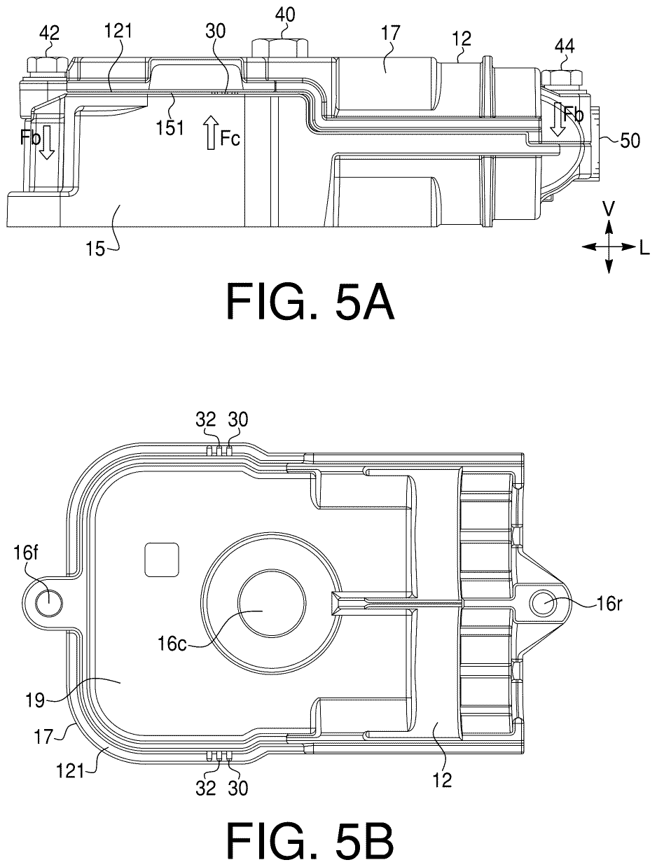

FIG. 5A is a side view of another embodiment of a connector 1 made in accordance with principles of the disclosed subject matter. In this embodiment, contacts 30 can be provided between the upper shield 12 and the lower shield 15 to provide both electrical grounding pathways and connective force locations between the upper shield 12 and the lower shield 15. The front bolt 42 and rear bolt 44 can exert a force Fb from the upper shield 12 to the lower shield 15 at the locations noted in FIG. 5A. A reaction force Fc can be concentrated at contacts 30 located at a position between the bolts 42, 44 as viewed from a transverse axis (or side view shown in FIG. 5A). The contacts 30 can be located/formed in either a lowermost surface 121 (in a vertical direction) of the upper shield 12, or an uppermost surface 151 (in a vertical direction) of the lower shield 15. The upper shield 12 can have a peripheral wall 17 that extends downward in a vertical axis direction from the top surface 19 to terminate at a lowermost surface 121 which can be configured to include at least one planar surface that is perpendicular to the vertical axis direction (e.g., perpendicular to a rotational axis RA or longitudinal axis of bolt 40). The contacts 30 can be formed in those portions of the lowermost surface 121 (or uppermost surface 151) that are in a plane substantially perpendicular to the vertical axis direction (e.g., perpendicular to a rotational axis RA or longitudinal axis of bolt 40) so that connective force from the bolts 40, 42, 44 create an opposing force that is an a direction opposed to the reactive contact force (see arrows Fc and Fb in FIG. 5A which are in 180 degree opposition with respect to each other).

FIG. 5B is a bottom view of the shield shell 10 of FIG. 5A and shows the contacts 30 molded or cast into opposite sides of the peripheral wall 17 of the upper shield 12. The contacts 30 are formed as a series of spherical bumps or nodules that project as hemispherical structures away from the plane that contains the planar portion of lowermost surface 121. Thus, a space S is created on either side of the contacts 30 and the space prevents both force and electrical grounding connection to occur at locations on either side of the contacts 30. Instead, both connective force and electrical grounding occur only at the contacts 30 and, depending on the flexibility and geometry of the upper shield 12, at areas surrounding or adjacent the bolts 42, 44. A front aperture 16f can be provided in a front portion of the upper shield 12 for bolt 42 to pass therethrough. A rear aperture 16r can be provided in a rear portion (opposed to the front portion along the longitudinal axis of the connector 1) of the upper shield 12 for bolt 44 to pass therethrough. A central aperture 16c can be located at a center of the upper shield 12 to allow bolt 40 to pass therethrough and connect ultimately with the mating component 20 (not shown in FIG. 5A, B) to secure the shield 10 to the mating component 20.

The disclosed subject matter relates to EMC shield connectors with contact force distribution characteristics. More particularly, the disclosed subject matters relates to EMC shield connectors that include a set-off structures (i.e., “contacts 30”) spaced from a bolt connector. The contacts 30 serve to distribute the contact force, and also provide grounding paths about the connector or shield 1 perimeter due to vertical spacing of the lowermost surface 114 from the uppermost surface 224 in the vertical axis direction (direction parallel to longitudinal axis/rotational axis RA direction of bolt 40), with the vertical spacing occurring between the contacts 30 in the longitudinal axis L and transverse axis T directions.

The contacts 30 can be cast into the upper shield structure 10 or into the mating component 20, and serve to concentrate grounding and contact force between upper shield structure 10 and the mating component 20 when the connective bolt 40 or bolts 40, 42, 43 connect the shield 10 to the mating component(s) 20.

While certain embodiments of the invention are described above, it should be understood that the invention can be embodied and configured in many different ways without departing from the spirit and scope of the invention.

It is contemplated that the shield 10 can be die-cast aluminum and the mating component 20 also be made of die-cast aluminum with the contacts 30, 32 integrally formed therein via the die-casting process. Thus, the contacts 30, 32 would be made of the same material and homogenous and integral with any of the upper shield 12, lower shield 15, a unitary shield body making up shield shell 10, and/or the mating component 20. The material that makes up the shield shell 10 or mating component 20 could alternatively be a different metal material such as steel or composites of steel, aluminum or other metals, ceramic materials, or plastics embedded with metal or ceramic shielding material such as metal fibers, meshes, nets or other known or future known EMC shielding materials. The contacts 30 can be opposed by concave structures in the opposing structure that seats the contacts 30 to provide secure predictable contact 30 locations and surface areas for electrical grounding and force distribution. The concavity could be of a depth that allows the contacts 30 to be located easily but maintains a space S between, for example, the lowermost surface 114 of the shield shell 10 from the uppermost surface 224 of the mating component 20 at locations at least immediately adjacent each contact 30 and possibly maintains a space S between contacts 30 and about a substantial portion (more than half) of the peripheral wall 18 of the shield shell 10 (or substantial portion of the periphery of the mating component 20).

It is also contemplated that the contacts 30 could be a separate structure that is not integral with either of the mating component 20 or shield shell 10 and, instead, is adhered, welded, bolted or otherwise attached to either or all of the mating component 20 and shield shell 10 before attachment of the shield shell 10 to the mating component 20. For example, concavities could be molded in any or all of the uppermost surface 224, lowermost surface 114, lowermost surface 121 of upper shield or uppermost surface 151 of the lower shield 15. Spheres, tubes or other structures that mate with the geometry of the concavities could then be attached or adhered within the concavities to form the contacts 30.

While we have described the connector 1 for use in a passenger automobile type vehicle's wiring harness, the connector 1 can also be applied to other vehicle wiring harnesses, including pickup trucks, SUVS, vans, tractor trailers, motorcycles, aircraft, trains, boats, and even spacecraft. In addition, any high voltage wire harness application could benefit from the presently disclosed subject matter including wiring for housing and commercial building and machine applications.

The height in the vertical axis direction of each contact 30 can be the same or differ from each other, and can be adjusted to optimize contact force and establish grounding electric pathways. The shield shell 10 can be made as a unitary cast structure or can be multiple parts (as shown in FIGS. 5A and B). Contacts 30 can be located between each of the multiple parts of the shield shell 10, or can be located only on the lowermost surface 114 of the shield shell 10 (and/or mating component 20). The number and position of contacts 30 can be determined based on each specific application, and on where and how force and grounding distributions are desired for a particular connector.

The mating component 20 can be a device such as a motor, inverter, alternator, battery, etc. to which shield shell 10 is attached. Alternatively, the mating component 20 can be a part of a multiple part shield shell 10. Further, the mating component 20 can be a separate structure that is configured to then attach the connector 1 to a device or bracket or other vehicle component.

While the wires 50 are shown as a pair of wires entering the shield shell along a longitudinal axis direction L, it is contemplated that the disclosed subject matter could be used with more than two wires, with a single wire, and with any or all wires extending into the shield shell at various directions other than (and including) the longitudinal axis direction L. Similarly, the planar surfaces 114, 224, 121, 151 can be located in various other orientations other than in a plane perpendicular to the vertical axis direction. The planar surface 114, 224, 121, 151 can reside entirely in a single plane or can have only portions thereof located in a single plane, with the single plane perpendicular to a rotational axis or longitudinal axis of the bolt 40 such that the connective force is normal to the portions of the planar surfaces 114, 224, 121, 151 that are located in the single plane. Of course, planar surfaces 114, 224, 121, 151 can also have portions thereof located in multiple planes that are all parallel to each other and normal to the connective force direction of the bolt 40.

The height of the contact 30 can also be adjusted, when contacts are located only on one side of bolt 40, to create a specific angle between the lowermost surface 114 and uppermost surface 224 when the bolt 40 is tightened. A larger angle allows for larger contact force to be distributed through the contacts 30, for example, in the embodiment of FIG. 1A.

The disclosed subject matter can include a method for concentrating force and electrical grounding pathways in a shield shell 10 connection to a mating structure 20 by providing a plurality of contacts 30 about a perimeter of at least one of the shield shell 10 and mating structure 20, connecting the shield shell 10 to the mating structure 20 by causing the contacts to come into contact with an opposing one of the shield shell 10 and mating structure 20 such that the shield shell 10 and mating structure 20 are spaced from each at locations between the contacts 30, thus creating electrical grounding pathways, and connective force pathways only at the contacts 30.

While the subject matter has been described in detail with reference to exemplary embodiments thereof, it will be apparent to one skilled in the art that various changes can be made, and equivalents employed, without departing from the scope of the invention as set forth in the claims.

What is claimed is:

1. An electrical connection system for a wire harness including an electromagnetically shielded cable, the electrical connection system comprising:
a first electrical terminal;
a shield shell covering at least a portion of the first electrical terminal and having a first substantially planar surface;
a mating component including a second substantially planar surface configured to oppose the first substantially planar surface;
at least one bolt configured to extend through at least a portion of each of the shield shell and the mating component; and
at least one contact protruding from at least one of the first substantially planar surface and the second substantially planar surface, the at least one contact abutting and forming a grounding connection with a different one of the first substantially planar surface and the second substantially planar surface when the bolt fastens the shield shell and the mating component together.

2. The electrical connection system of claim 1, wherein the mating component is one of an inverter, a motor, and a second shield shell.

3. The electrical connection system of claim 1, wherein the at least one contact is configured as a plurality of semispherical protrusions extending from the at least one of the first substantially planar surface and the second substantially planar surface.

4. The electrical connection system of claim 1, wherein the at least one bolt is a single bolt having a rotational axis, and the at least one contact extends away from the at least one of the first substantially planar surface and the second substantially planar surface in a direction parallel with the rotational axis of the single bolt.

5. The electrical connection system of claim 4, wherein the at least one contact is located only on a first side of the bolt such that when the bolt is tightened, the at least one contact causes the first substantially planar surface to be at an angle with respect to the second substantially planar surface.

6. The electrical connection system of claim 5, wherein the at least one contact includes a plurality of contacts configured in an asymmetrical configuration about the single bolt in a plane that contains the first substantially planar surface.

7. The electrical connection system of claim 1, wherein the at least one contact includes a plurality of contacts configured in a symmetrical configuration about the bolt.

8. The electrical connection system of claim 1, wherein the at least one bolt includes a first bolt and a second bolt, and the at least one contact is positioned at a location between the first bolt and the second bolt in a direction perpendicular to a rotational axis of the first bolt and a rotational axis of the second bolt, such that a contact pathway is formed between the shield shell and the mating component at the location between the first bolt and second bolt.

9. The electrical connection system of claim 1, wherein the shield shell is a concave structure that includes a top surface bounded on at least three sides by a peripheral wall, and a lowermost surface of the peripheral wall forms the first substantially planar surface with the at least one contact projecting from the lowermost surface.

10. The electrical connection system of claim 1, wherein the shield shell is a concave structure that includes a top surface bounded on at least three sides by a peripheral wall, and a lowermost surface of the peripheral wall forms the first substantially planar surface, and the at least one contact projects upward from the second substantially planar surface of the mating component and contacts the lowermost surface of the peripheral wall of the shield shell at an isolated location to form an electric grounding pathway between the shield shell and the mating component at that isolated location.

11. The electrical connection system of claim 1, wherein the shield shell includes a first shell formed as a concave structure that includes a top surface bounded on at least three sides by a peripheral wall, and a lowermost planar surface of the peripheral wall forms the first substantially planar surface, and
the mating component is a second shell of the shield shell, and includes an uppermost planar surface that mates with the lowermost planar surface of the peripheral wall, with the at least one contact projecting from at least one of the uppermost planar surface and the lowermost planar surface in a direction parallel with a rotational axis of the at least one bolt, such that an electrical grounding contact pathway is formed between the first shell and the second shell by the at least one contact, and uppermost and lowermost are defined in a direction parallel with the rotational axis of the bolt.

12. An electrical connection system for shielding an electrical terminal, the electrical connection system comprising:
a shield shell configured to cover at least a portion of the electrical terminal and having a first substantially planar surface;
a mating component including a second substantially planar surface configured to oppose the first substantially planar surface;
at least one bolt having a rotational axis and configured to extend through at least a portion of each of the shield shell and the mating component; and
at least one contact protruding from at least one of the first substantially planar surface and the second substantially planar surface and abutting and forming a grounding connection with a different one of the first substantially planar surface and the second substantially planar surface, and the first substantially planar surface and the second substantially planar surface are perpendicular to the rotational axis of the at least one bolt.

13. The electrical connection system of claim 12, wherein the mating component is one of an inverter, a motor, and a second shield shell.

14. The electrical connection system of claim 12, wherein the at least one contact is configured as a plurality of semispherical protrusions extending from the at least one of the first substantially planar surface and the second substantially planar surface.

15. The electrical connection system of claim 12, wherein a space exists between the first substantially planar surface and the second substantially planar surface on either side of the at least one contact such that an electrical connection between the shield shell and mating component runs through the at least one contact.

16. An electrical connection system for a connector of a wire harness, comprising:
a first housing shell having a first substantially planar surface;
a mating component having a second substantially planar surface configured to mate with the first substantially planar surface of the first housing shell to contain and shield the connector; and
a bolt extending in a first direction through at least a portion of each of the first housing shell and mating component, wherein
at least one of the first substantially planar surface and second substantially planar surface includes a plurality of contacts extending in a direction parallel to the first direction and away from the at least one of the first substantially planar surface and second substantially planar surface, the contacts are located about a periphery of the at least one of the first substantially planar surface and second substantially planar surface, the plurality of contacts are configured to contact and form a grounding connection with the substantially planar surface of an opposing one of the first substantially planar surface and second substantially planar surface.

17. The electrical connection system of claim 16, wherein the mating component is one of an inverter, a motor, and a second shield shell of a two-part shield shell.

18. The electrical connection system of claim 16, wherein locations of the plurality of contacts being asymmetrical about the bolt in a side view of the electrical connection system such that the first substantially planar surface and second substantially planar surface are at an angle with respect to each other when the bolt is tightened to secure the first housing shell to the mating component.

19. The electrical connection system of claim 16, wherein the first substantially planar surface and the second substantially planar surface are spaced from each other on either side of each of the plurality of contacts such that electrical connection between the first housing shell and the mating component runs through each of the contacts.

20. The electrical connection system of claim 16, wherein the first housing shell is a cast aluminum component, and the mating component is a metal component, and the plurality of contacts concentrates both contact force and electrical connection between the first housing shell and the mating component at the plurality of contacts.
